(19) United States
(12) Patent Application Publication
(10) Pub. No.: US 2002/0010752 A1
(43) Pub. Date: Jan. 24, 2002

(54) Information processing apparatus, method thereof, information processing system, and medium

(76) Inventors: Mari Horiguchi, Tokyo (JP); Harumi Kawamura, Tokyo (JP)

Correspondence Address: William S. Frommer, Esq., FROMMER LAWRENCE & HAUG LLP, 745 Fifth Avenue, New York, NY, 10151, US

(21) Appl. No.: 09/819,399

(22) Filed: Mar. 28, 2001

(30) Foreign Application Priority Data
Mar. 30, 2000 (JP) 2000-097940

(51) Int. Cl. G06F 15/167

(52) U.S. Cl. 709/213; 709/229

(57) ABSTRACT

A controller can newly add a BBS board type. A target device assigns a Board Type list Descriptor's list ID to SID's Root_list_ID. Initially, the target device is provided with only the Board Type list Descriptor. The Board Type list Descriptor's List_type specifies a newly defined General Board. The controller issues an instruction for creating an object to the Board Type list Descriptor. The target creates an object with child list ID accordingly. The controller writes to the Child list ID an ID value of the board type to be created, thus adding a new board type.

### BACKGROUND OF THE INVENTION

1. Field of the invention

The present invention relates to an information processing apparatus connected to, say, an IEEE 1394 serial data bus, method thereof, information processing system, and medium.

2. Description of Related Art

In recent years, there have been developed AV devices capable of mutually transmitting information via a network using, say, an IEEE 1394 serial data bus standardized by IEEE (The institute of Electrical and Electronics Engineers). This network system can mutually control AV devices connected to the above network by using specified digital interface commands (hereafter referred to as AV/C commands) according to the AV/C Command Transaction Set.

FIG. 1 shows a configuration example of a network using the IEEE 1394 serial data bus. The network system in FIG. 1 comprises an IRD (Integrated Receiver Decoder) 71 and a DVCR (digital video cassette recorder) 81 such as D-VHS connected to an IEEE 1394 serial data bus 80 (hereafter referred to as the bus 80).

A controller 72 of the IRD 71 accepts various user's functional instructions such as selecting channels, reserving programs, and the like for controlling IRD 71 operations. The controller 72 should be able to control the DVCR 81 by using AV/C commands as specified digital interface commands. ACS antenna 74 receives a digital signal for digital satellite broadcasting transmitted from a communication satellite (not shown) and outputs the reception signal to a tuner subunit 73. Under control of the controller 72, the tuner subunit 73 extracts a specified channel signal from the digital signal input from the CS antenna 74 and outputs the extracted signal to a VCR subunit 84 of the DVCR 81 via the bus 80.

A controller 82 of the DVCR 81 accepts various user's functional instructions such as reproduction, recording, fast forward, rewind, recording reservation, and the like for controlling overall operations of the DVCR 81. Under control of the controller 82, an analog tuner subunit 83 extracts a specified channel signal from an input analog signal and outputs the extracted signal to the VCR subunit 84.

The VCR subunit 84 records a picture signal on magnetic tape (not shown). Picture signals are input from an analog tuner subunit 83 or is supplied from the IRD 71's tuner subunit 73 via the bus 80.

An electronic device such as the IRD 71 or the DVCR 81 connected to the bus 80 is called a unit. For interaction between units, a descriptor is defined in the general specification for AVIC commands (AV/C Command Transaction Set), namely the AV/C Digital Interface Command Set General Specification (hereafter referred to as the AV/C general). The descriptor is used for mutually reading and writing information stored in respective units. The AV/C general is detailed in “AV/C Digital Interface Command Set General Specification (Version 3.0, Apr. 15, 1998)”. A functional entity given to the unit is called a subunit. In FIG. 1, examples are the IRD 71's digital tuner subunit 73, DVCR 81's VCR subunit 84, and the like.

Incidentally, the above-mentioned DVCR 81 is called a target device which can be controlled by another unit's controller, say, the IRD 71's controller 72. For example, there may be provided a subunit called an AV/C Bulletin Board Subunit (BBS). This is detailed in “AV/C Bulletin Board Subunit General Specification, Rev. 0.38”, 1394 Trade Association (Jan. 27, 1999). The BBS is provided as a space for allowing subunit-independent information to be shared among other units.

The BBS predefines one or a plurality of board types available to a BBSequipped device (target device). When the controller reads or writes the target device's BBS, the controller specifies and reads a root list ID for board types available to the target device. The controller then sends a write instruction to the target device. On the other hand, the target device returns an accept in response to the instruction sent from the controller (see AV/C BBS version 1.0).

According to this architecture, the controller is limited to handle just types of boards preinstalled on a target device. Consequently, it is not possible to fulfill a controller's request to handle a type of boards not installed on the target device.

Basically, when the BBS is used, the controller is responsible for writing. The target device is not responsible for the written contents. In the future, there can be a device which has a large amount of memory, is equipped with the BBS, provides a space for sharing information by the BBS, and does not deten-nine board types to be handled. In such a case, there may arise a request that the controller later create a controllable board type and control it.

However, the current standard does not specify a method of adding or creating a new board type for the BBS.

### BRIEF SUMMARY OF THE INVENTION

The present invention has been made in consideration of the foregoing. It is therefore an object of the present invention to provide an information processing apparatus, method thereof, information processing system, and medium so that the controller can newly add a board type for the BBS.

An information processing apparatus according to the present invention comprises shared information storage means for storing information shareable among other networked information processing apparatuses and including one or more types of information description area. This apparatus solves the above-mentioned problems by responding to a request from the another networked information processing apparatus; and comprising information description area generation means for generating a new information description area having an identification information write area in which the another information processing apparatus writes identification information indicating a type of the information description area.

Further, an information processing method according to the present invention is applied to an information processing apparatus comprising shared information storage means for storing information shareable among other networked information processing apparatuses and including one or more types of information description area. This method solves the above-mentioned problems by responding to a request from the another networked information processing apparatus; and generating a new information description area having an identification information write area in which the another information processing apparatus writes identification information indicating a type of the information description area.

Next, an information processing apparatus according to the present invention solves the above-mentioned problems by comprising: request means for requesting to generate a specified type of information description area from another information processing apparatus having shared information storage means for storing information shareable among networked information processing apparatuses and including one or more types of information description area; and write means for writing identification information indicating the specified type of the information description area to a write area for identification information indicating a type of the information description area provided in the information description area newly generated by the another information processing apparatus in response to the request.

Moreover, an information processing apparatus according to the present invention solves the above-mentioned problems by: requesting to generate a specified type of information description area from another information processing apparatus having shared information storage means for storing information shareable among networked information processing apparatuses and including one or more types of information description area; and writing identification information indicating the specified type of the information description area to a write area for identification information indicating a type of the information description area provided in the information description area newly generated by the another information processing apparatus in response to the request.

Then, an information processing system according to the present invention solves the above-mentioned problems by at least comprising first and second information processing apparatuses. The first information processing apparatus comprises shared information storage means for storing information shareable among other networked information processing apparatuses and including one or more types of information description area and information description area generation means for, in response to a request from the another networked information processing apparatus, generating a new information description area having an identification information write area in which the another information processing apparatus writes identification information indicating a type of the information description area. The second information processing apparatus comprises request means for requesting the first information processing apparatus to generate a specified type of information description area and write means for writing identification information indicating the specified type of the information description area to a write area for the identification information indicating a type of the information description area provided in the information description area newly generated by the first information processing apparatus in response to the request.

Moreover, an information processing method according to the present invention solves the above-mentioned problems by requesting to generate a specified type of information description area from shared information storage means for storing information shareable among other networked information processing apparatuses and including one or more types of information description area, generating a new information description area having an identification information write area for writing identification information indicating a type of the information description area in response to the above request, and writing identification information indicating the specified type of the information description area to a write area for the identification information indicating a type of the information description area provided in the information description area newly generated in response to the above request.

A medium according to the present invention solves the above-mentioned problems by allowing an information processing apparatus to execute a program comprising the steps of: inputting an request from another networked information processing apparatus; and, in response to a request from the another networked information processing apparatus, generating a new information description area having an identification information write area in which the another information processing apparatus writes identification information indicating a type of the information description area.

A medium according to the present invention solves the above-mentioned problems by allowing an information processing apparatus to execute a program comprising the steps of: requesting to generate a specified type of information description area from another information processing apparatus having shared information storage means for storing information shareable among networked information processing apparatuses and including one or more types of information description area; and writing identification information indicating the specified type of the information description area to a write area for identification information indicating a type of the information description area provided in the information description area newly generated by the another information processing apparatus in response to the request.

A medium according to the present invention solves the above-mentioned problems by allowing an information processing apparatus to execute a program comprising the steps of: requesting to generate a specified type of information description area from shared information storage means for storing information shareable among networked information processing apparatuses and including one or more types of information description area; in response to the above request, generating a new information description area having an identification information write area for writing identification information indicating a type of the information description area; and writing identification information indicating the specified type of the information description area to a write area for identification information indicating a type of the information description area provided in the information description area newly generated in response to the above request.

According to the information processing apparatus, the method thereof, the information processing system, and the medium of the present invention, a request to generate a specified type of information description area is issued to shared information storage means for storing information shareable among networked information processing apparatuses and setting one or more types of information description area. In response to this request, there is generated a new information description area having an identification information write area for writing identification information indicating a type of the information description area. Identification information indicating the specified type of the information description area is written to a write area for identification information indicating a type of the information description area provided in the newly generated information description area. According to AV/C general specifications using an IEEE 1394 serial data bus, for example, the controller can newly add a BBS board type.

According to the present invention, the controller can later add a board type to a device which has a large amount of memory and the BBS, and provides networked devices with the BBS as a space for sharing information. The controller can handle, say, the most recent board type. Since the present invention allows a board type to be added later, it is unnecessary for memory to store a complete list of board types available to devices at the time of shipment. It is possible to newly create a list of board types according to user's selection, permitting an effective use of memory.

### BRIEF DESCRIPTION OF THE SEVERAL VIEWS OF THE DRAWING

FIG. 1 is a block diagram showing a configuration example of an associated network system;

FIG. 2 is a block diagram showing a configuration example of a network system according to an embodiment of the present invention;

FIG. 3 is a block diagram showing a concrete configuration of an IRD;

FIG. 4 is a block diagram showing a concrete configuration of a DVCR;

FIG. 5 shows a structural model of a board type having a single board;

FIG. 6 shows a structural model of a board type having one or more boards;

FIG. 7 illustrates positioning of a general board type list according to the embodiment of the present invention;

FIG. 8 shows a detailed data structure of the board type list descriptor in FIG. 7;

FIG. 9 shows a detailed data structure of list_specific_information in FIG. 8;

FIG. 10 shows an allocation table of list IDs for the BBS version 1.0;

FIG. 11 shows an allocation table of list types;

FIG. 12 shows an allocation table of board types;

FIG. 13 is a flowchart showing a flow of process'ng until a new board type is created in the system according to the embodiment of the present invention;

FIG. 14 is a flowchart showing another flow of processing until a new board type is created in the system according to the embodiment of the present invention;

FIG. 15 shows a WRITE OPEN command format;

FIG. 16 shows a READ command format;

FIG. 17 shows a CREATE command format;

FIG. 18 shows the content of the result field in FIG. 17;

FIG. 19 shows the format of subfunction_1_specification for subfunction_{—}1=00₁₆ in FIG. 17;

FIG. 20 shows result field values and meanings thereof;

FIG. 21 shows the format of subfunction₁₃ 1_specification for subfunction_{—}1=01₁₆ in FIG. 17;

FIG. 22 shows field values in FIG. 21;

FIG. 23 shows a CLOSE command format;

FIG. 24 diagrams a detailed flow for creating a board type at step S18 in FIGS. 13 and 14; and

FIG. 25 is a block diagram exemplifing a computer configuration according to the present invention.

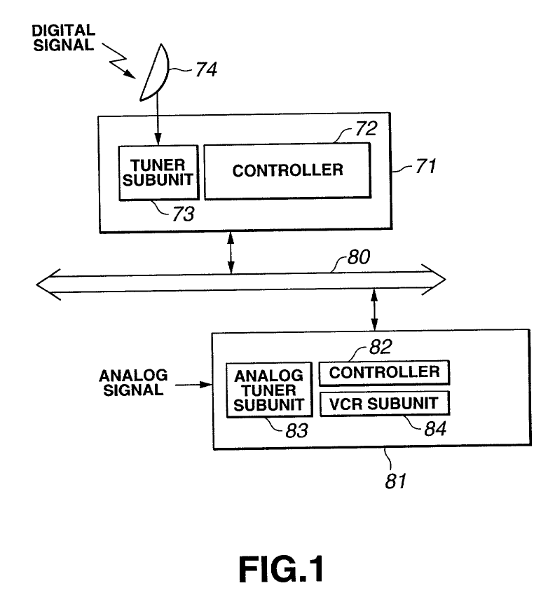

### DETAILED DESCRIPTION OF THE INVENTION

Embodiments of the present invention will be described in further detail with reference to the accompanying drawings. In this specification, the tenn “system” refers to a whole apparatus which comprises a plurality ofapparatuses, means, and the like.

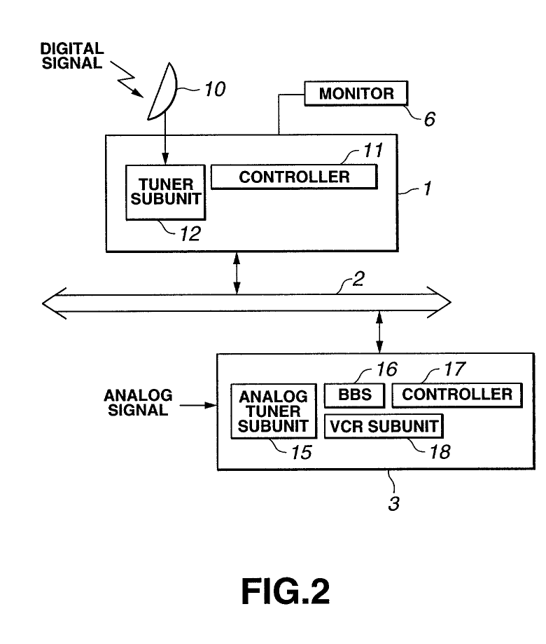

FIG. 2 schematically shows a network system configuration according to an embodiment of the present invention.

The network system in FIG. 2 comprises an IRD 1 and a DVCR (digital video cassette recorder) 3 such as D-VHS connected to an IEEE 1394 serial data bus 2 (hereafter referred to as the bus 2). Obviously, the bus 2 can connect with not only IRD and DVCR, but also electronic devices equipped with IEEE 1394 terminals such as a personal computer, a hard disk drive, a CD player, a monitor, a digital video camera, an MD (trademark) player, and the like.

An IRD controller 11 in the IRD 1 accepts user's operations such as selecting channels or reserving programs for controlling overall operations of the IRD 1. The controller 11 controls the DVCR 3 by using the above-mentioned AV/C commands as specified digital interface commands. A CS antenna 10 receives a digital signal for digital satellite broadcasting transmitted from a communication satellite (not shown) and outputs the reception signal to a tuner subunit 12. Under control of the controller 11, the tuner subunit 12 extracts a specified channel signal from the digital signal input from the CS antenna 10 and outputs the extracted signal to a VCR subunit 18 of the DVCR 3 via the bus 2. Further, the controller 11 reads and writes a BBS (Bulletin Board Subunit) 16 of the DVCR 3.

A controller 17 of the DVCR 3 accepts various user's operations such as instructing reproduction or reserving programs, and the like for controlling overall operations of the DVCR 3. The controller 17 also reads and writes the BBS 16. Under control of the controller 17, an analog tuner subunit 15 extracts a specified channel signal from an input analog signal and outputs the extracted signal to the VCR subunit 18.

The VCR subunit 18 records a picture signal on magnetic tape (not shown). Picture signals are input from an analog tuner subunit 15 or from the IRD l's tuner subunit 12 via the bus 2.

The BBS 16 is provided as a space for allowing subunit-independent information to be shared among other units.

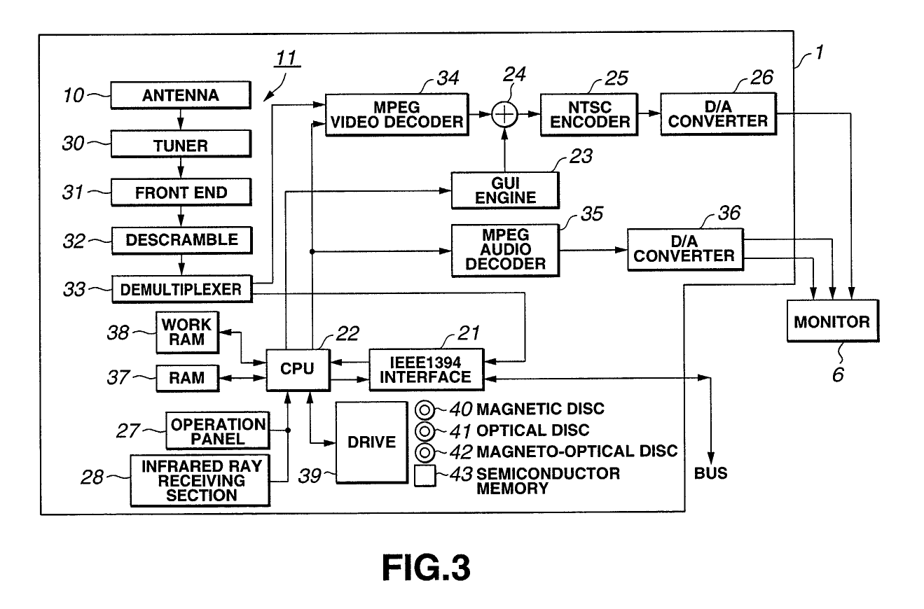

FIG. 3 shows a detailed configuration of the network system's IRD 1 in FIG. 2.

In FIG. 3, a signal is transmitted from the DVCR 3 or other units (not shown) via the bus 2 and is input to a CPU 22, a major section of the controller 11, via an IEEE 1394 interface 21. According to the input signal, the CPU 22 generates a control signal for creating image data or GUI (Graphical User Interface) data for representing, say, menu screens and outputs the generated signal to a GUI engine 23. The GUI engine 23 outputs the generated GUI data to an NTSC (National TV Standards Comnmittee) encoder 25 via the adder 23. The GUI data is converted to NTSC data, is converted to an analog signal in a D/A converter 26, and then is displayed on a monitor 6 as various menu screens. The CPU 22 also reads and writes the DVCR 3's BBS.

A user operates an operation panel 27 or a remote coimnander (not shown) to select an intended device such as DVCR 3 and the like connected to the bus 2 and specify processing (function) to be performed by the selected device. When the user operates the remote commander, an infrared ray receiving section 28 receives an infrared ray signal representing the user's operation from the remote commander. The CPU 22 generates a control signal based on the signal input from the operation panel 27 or the infrared ray receiving section 28 for representing the user's operation. The control signal is output to an MPEG video decoder 34 and an MPEG audio decoder 35 or is supplied to the DVCR 3 via the IEEE 1394 interface 21 and the bus 2. The CPU 22 receives a broadcast wave using the antenna 10 and displays it on the monitor m 6 or supplies it to the DVCR 3 and the like via the IEEE 1394 interface 21 and the bus 2. It may be preferable to connect the monitor to the bus 2.

The antenna 10 receives a broadcast wave from a satellite (not shown) and outputs it to a tuner 30 in the tuner subunit 12. The tuner 30 selects a specified channel from the received broadcast wave according to the control signal input from the CPU 22. A reception signal corresponding to the selected broadcast wave is demodulated and error corrected in a front end section 31, and then is output to a descramble section 32. An IC card (not shown) inserted into the IRD body stores cryptographic key information about subscribed channels. Out of the input data, the descramble section 32 outputs multiplexed data comprising only subscribed channel data to a demultiplexer 33 based on this cryptographic key information. The demultiplexer 33 sorts the input multiplexed data according to channels. Based on the input from CPU 22, the demultiplexer extracts only user-specified channel data. The dernultiplexer outputs a video stream comprising picture packets to the MPEG video decoder 34 and an audio stream comprising speech packets to an MPEG audio decoder 35.

The MPEG video decoder 34 decodes the video stream to restore video data before compression encoding and outputs the restored data to the NTSC encoder 25. The NTSC encoder 25 converts video data to a brightness signal and a color-difference signal based on the NTSC system and outputs the converted signals as NTSC data to a D/A (digital/analog) converter 26. The D/A converter 26 converts the NTSC data to an analog signal. This analog signal is sent to the monitor 6 for displaying pictures.

The MPEG audio decoder 35 decodes the audio stream to restore PCM (Pulse Code Modulation) audio data before compression encoding and outputs this data to the D/A converter 36. The D/A converter 36 converts the PCM audio data to an analog signal, generating audio signals for R and L channels. These audio signals are sent to a speaker (not shown) mounted on the monitor 6.

RAM 37 stores various programs and data for controlling and performing IRD 1 operations. When the IRD 1 is equipped with a hard disk drive, a hard disk can store these programs and data. The stored programs and data are read into the CPU 22 as needed. The RAM 37 is also provided with registers for maintaining descriptors compliant with the AV/C general. Work RAM 38 stores data and the like generated in accordance with program execution.

A drive 39 is connected to the CPU 22 and can be used for a magnetic disk 40, an optical disk 41, a magneto-optical disk 42, or semiconductor memory 43 whose shape is similar to a card, stamp, sheet, stick, and the like. The CPU 22 can read data stored in these storage devices.

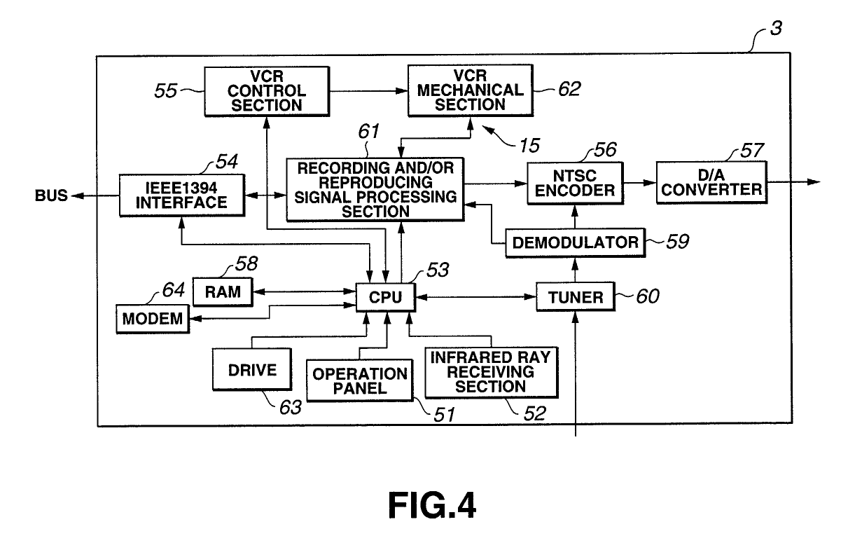

FIG. 4 shows a detailed configuration of the DVCR 3.

In FIG. 4, when a user operates an operation panel 51 or a remote commander (not shown), the CPU 53 is supplied with a signal corresponding to the user operation from the operation panel 51 or an infrared ray receiving section 52. Namely, when the user operates the remote commander, the infrared ray receiving section 52 receives an infrared ray signal indicating the user operation from the remote commander and outputs this signal to the CPU 53. Further, the CPU 53 is supplied with control signals and various data from other devices (units) connected to the bus 2 via the bus 2 and the IEEE 1394 interface 54.

Based on these signals, the CPU 53, a major section of the controller 17, generates, say, a control signal for controlling a VCR control section 55 and outputs this control signal to the VCR control section 55 in a VCR subunit 15 When picture data is input from other devices via the bus 2 and the IEEE 1394 interface 54, the CPU 53 sends this data to a recording and/or reproducing signal processing section 61. By controlling the VCR mechanical section 62 via the VCR control section 55, the CPU 53 allows the recording and/or reproducing signal processing section 61 to record a recording signal generated from the picture data on video cassette tape (not shown) mounted in the VCR mechanical section 62. The recording signal recorded on the video cassette tape is reproduced and is sent to the recording and/or reproducing signal processing section 61 for restoring the picture data. The CPU 53 also reads and writes the BBS in the RAM 58.

The restored picture data is sent to an NTSC encoder 56 and is converted to NTSC data. The picture data is converted to an analog signal in a D/A converter 57, and then is output to a display apparatus such as a monitor (not shown) for a display purpose. Alternatively, the picture data is sent to other networked devices via the IEEE 1394 interface 54 and the bus 2. The monitor may be connected to the bus 2.

When a video cassette tape (not shown) is mounted in the VCR mechanical section 62, the VCR control section 55 issues to the CPU 53 a signal indicating that the video cassette tape is mounted. When receiving this signal, the CPU 53 displays a symbol or a character on the operation panel 51 for indicating a signal reception event. Alternatively, the CPU 53 turns on an LED or uses other means to notify a user that the video cassette tape is inserted in the DVCR.

When an antenna (not shown) receives a surface broadcast wave, a tuner 60 selects a specified channel from the received surface broadcast wave according to a control signal input from the CPU 53. The reception signal corresponding to the selected broadcast wave is demodulated in a demodulator 59 and is sent to the recording and/or reproducing signal processing section 61 or the NTSC encoder 56. When the reception signal is sent to the recording and/or reproducing signal processing section 61, it is converted to a recording signal under control of the CPU 53. The converted signal is recorded on video cassette tape (not shown) in the VCR mechanical section 62 controlled by the VCR control section 55. The reception signal is sent to the NTSC encoder 56 and is converted to NTSC data. This signal is converted to an analog signal in the D/A converter 57, and then is output to a display apparatus such as a monitor (not shown) for a display purpose. Alternatively, the signal is sent to other networked devices via the IEEE 1394 interface 54 and the bus 2.

The controller 11 (CPU 22) in the IRD 1 issues a CREATE instruction for objects (to be described later). Based on this instruction, the CPU 53 (controller 17) executes a function for newly creating a board in the BBS, namely creating an object with a child list ID (to be described later). For executing this function, the RAM 58 stores a program according to the present invention, template data for an object with child list ID to be created (to be described later), various programs and data for DVCR 3's operational control or computation, and the like. When the DVCR 3 is equipped with a hard disk drive, it is possible to store these programs and data in the hard disk. The program and data are read into the CPU 53 as needed. The RAM 58 is provided with registers for maintaining descriptors corresponding to the AV/C general and includes a memory space as the BBS 16. The RAM 58 also functions as work RAM for storing data generated in accordance with program execution. The above-mentioned object, object creation, a board, a child list ID, and the like will be described in more detail below.

A drive 63 is connected to the CPU 53. Like the case with the IRD 1, the drive can be used for, say, a magnetic disk, an optical disk, a magneto-optical disk, or semiconductor memory whose shape is similar to a card, stamp, sheet, stick, and the like. The CPU 53 can read data stored in these storage devices.

A modem 64 is controlled by the CPU 53 and is connected to a public switching line such as a telephone line.

As will be described hereinafter, the present invention requires a program for implementing functions such as creating a BBS board type (to be described later) and template data for objects with child list ID to be created. For example, the program and data can be compressed and stored in built-in nonvolatile memory, hard disk, or the like in advance. It is also possible to read the program and data from the magnetic disk, optical disk, magneto-optical disk, or semiconductor memory which stores the program and data and is inserted in the drive 63. Further, it is possible to download the program and data by means of data communication via the modem 64 such as Internet or via the IEEE 1394 interface 54. Alternatively, the tuner 60 can be used to extract a signal for the program superimposed on a broadcast signal and stores the signal in the RAM 58, the hard disk, and the like. When the program and data are downloaded from a network during data communication using Internet, it is necessary to enter a URL (uniform resource locator) for accessing a server which supplies the program and data. For eliminating the need for entering URLs, it may be preferable to store the pertinent URL in the RAM 58 or hard disk and automatically access the server and perform a download according to an instruction from a user or the IRD 1.

The embodiment of the present invention provides the examples in which the DVCR 3 loads the program and data from Internet, the magnetic disc, optical disc, magneto-optical disc, or semiconductor memory for implementing the function such as creating board types in the BBS. The invention is not limited thereto. The IRD 1 can read the program and data from these storage devices. It is also possible to use the tuner 30 to download the program and data transmitted by data communication via the IEEE 1394 interface 54 or digital satellite communication. In this case, the program and data are temporarily stored in the RAM 37 or the hard disc, and are transferred to the DVCR 3 via the bus 2. Then, the DVCR 3's CPU 53 writes the program to the RAM58 or the hard disc.

A board type to be newly created in the BBS is described in detail hereafter.

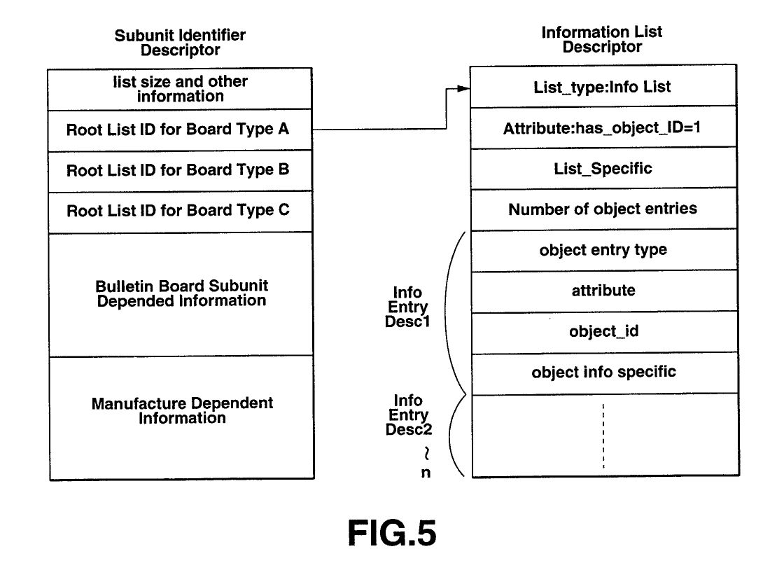

FIG. 5 shows a configuration example in a BBS block. FIG. 5 exemplifies a board type which is defined in the standard to have only one board. The board type comprises an SID (Subinit Identifier Descriptor) and an information list descriptor. There is provided only one SID in a subunit. The SID describes information about subunit capabilities and features. The information list descriptor is a board directly referenced by the corresponding SID.

The SID is a list specified in the AV/C general standard and is required for each subunit. When the controller first accesses the BBS, this list is read.

The SID contains basic information for reading and writing lists in the BBS. This information includes pointers to root lists directly linked to the BBS. They are provided as root list IDs in the SID. Namely, the SID begins with the list size and other information, followed by root list IDs. Each board type is provided with one root list ID whose value is defined in the standard officially. The root list ID specifies an information list descriptor. The controller reads a root list ID in the SID and compares it with the root list ID for an intended board type. This makes it possible to confinn whether the target BBS contains an intended board type.

The information list descriptor contains list information (Info List) as List_Type, has_object_ID as an attribute, List_Specific, and the number of object entries. The information list descriptor is further followed by information entry descriptors Info Entry Desc 1 to Info Entry Desc n. Each information entry descriptor comprises an object entry type (object entry type), an attribute (attribute), an object_id, and an object information specific (object info specific).

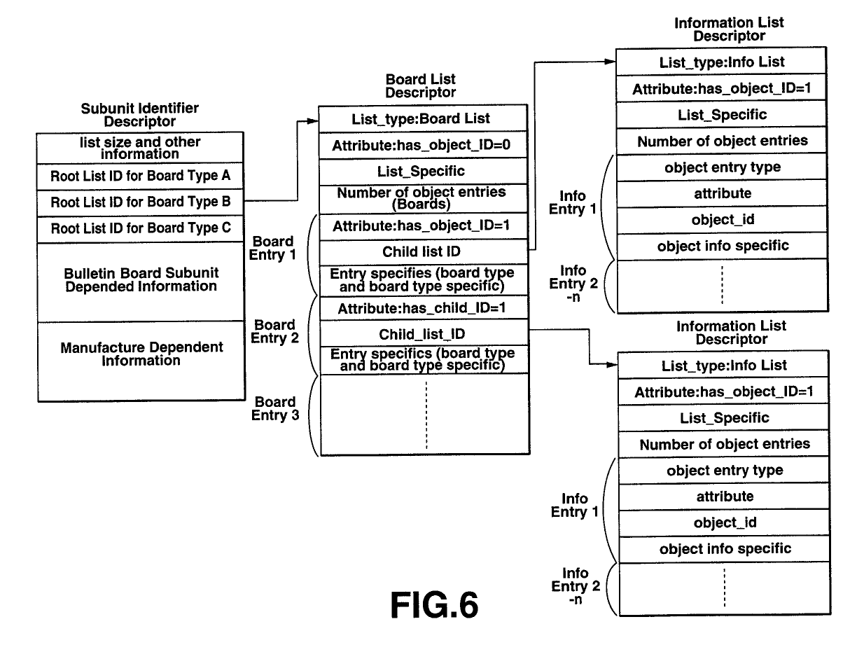

FIG. 6 exemplifies a board type which is capable of having a plurality of boards with the same board type. This board type comprises the SID, a board list descriptor, and an information list descriptor. The board list descriptor provides a list of a plurality of boards directly referenced by the SID. The information list descriptor indicates a board referenced from a child ID of the board list descriptor.

The board list descriptor is provided between the SID and the information list descriptor. The SID contains root list IDs for the board list descriptor.

The board list descriptor comprises List_Type as a board list, has_object_ID as an attribute, List_Specific, and the number of object entries. There are provided board entries Board Entry 1 to Board Entry n. Each board entry comprises an attribute as has_child_ID, a child list ID, and Entry specifics. The child list ID corresponds to the information list descriptor. The information list descriptor has the same configuration as in FIG. 5.

For example, a target device can newly create a BBS board type, namely an object with child list ID based on a CREATE instruction for objects from the controller. For implementing this, the present invention provides a configuration which allows the controller to newly add or create one BBS board type of the target device. A board type for which the controller can newly create a target device is hereafter referred to as a general board type.

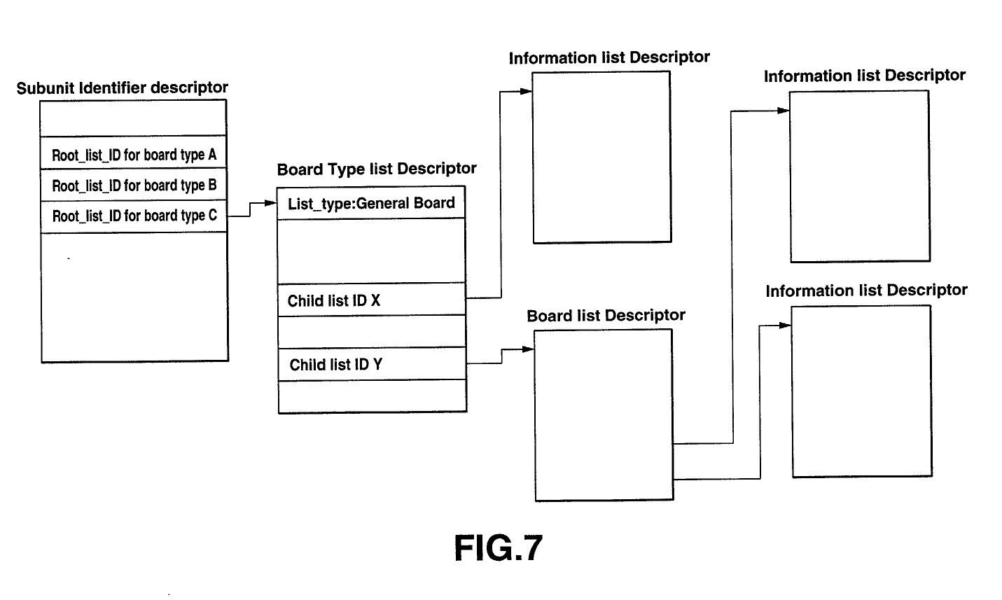

FIG. 7 illustrates positioning of a general board type list descriptor specified by a root list ID in the SID according to the embodiment of the present invention. FIG. 7 oimts the same data structures as those in FIGS. 5 and 6 and depicts only portions needed for the description.

The board type list descriptor is provided between the SID and the information list descriptor or the board list descriptor. The SID contains root list IDs for the board type list descriptor. In other words, a board type list descriptor according to the embodiment of the present invention can be specified by a root list ID in the standardized SID.

The board type list descriptor's List_Type describes the newly defined general board type. The child list ID corresponds to the information list descriptor as in FIG. 5 or the board list descriptor as in FIG. 6. In other words, this board type list descriptor's child list ID is same as the board list descriptor's child list ID, and is capable of specifying not only the information list descriptor, but also the board list descriptor.

Specifically, a target device (DVCR 3 in FIG. 2) is assigned a board type list descriptor's list ID for the SID's root list ID. Initially, the target device is provided with only the board type list descriptor. When the controller sends an instruction for creating an object to the board type list descriptor, the target device creates an object with child list ID. Thereafter, the controller can add board types of any configuration in FIG. 5 or 6 by writing an ID value of the board type to be created to the child list ID.

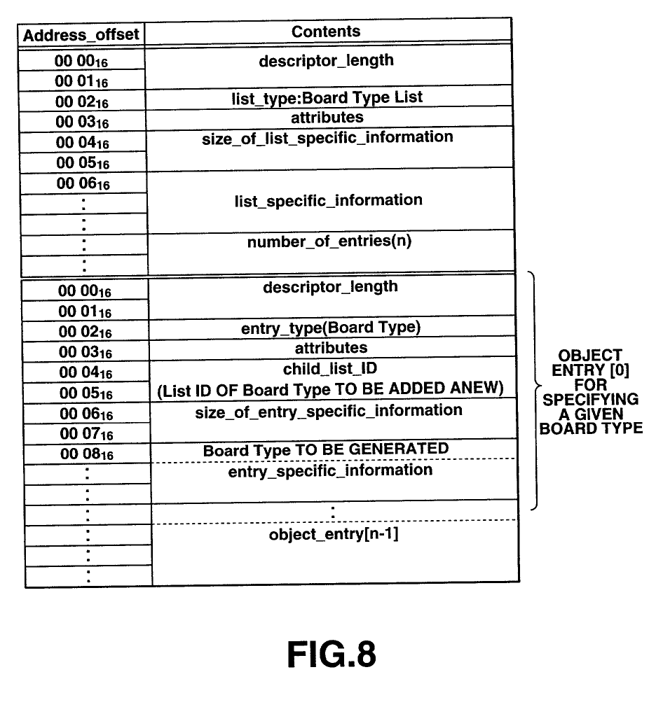

FIG. 8 shows a detailed data structure of the board type list descriptor in FIG. 7.

In FIG. 8, descriptor_length describes a descriptor length. List_type identifies a board type list. Attributes provides the description according to the AV/C general standard. Size_of_list_specific_information describes a length of list_specific_information. List_specific_information contains detailed information about the board type list. Nunber_of_entries specifies an entry number.

The descriptor_length describes the length of an object entry for specifying one board type. The entry_type contains a value indicating an object entry. In this example, the entry_type describes a board type to be newly defined as an entry type. The attributes contains a value indicating that the object has a child list ID. The child_list_ID describes the list ID of the board type to be provided anew. Two high-order bytes are set to 11₁₆. Two low-order bytes contain an ID using a value for the board type to be newly provided by the controller. The size_of_entry_specific_information describes the length of entry specific_information. The entry_specific_information contains detailed information about the entry. The entry_specific_information “0008₁₆” describes a board type to be created.

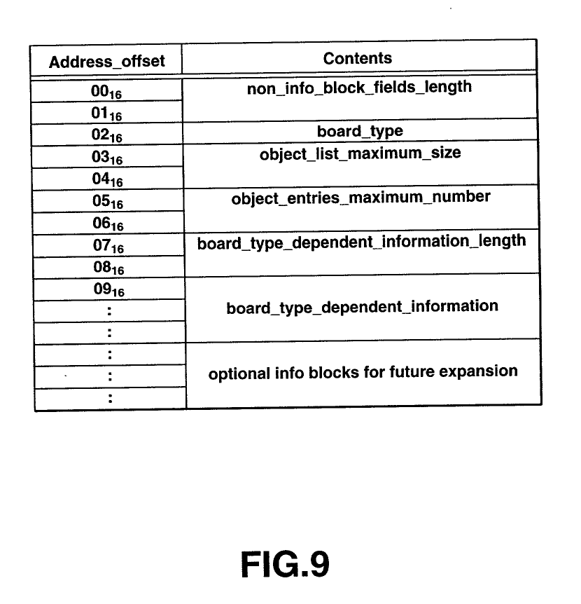

FIG. 9 shows a detailed data structure of list_specific_information in FIG. 8. When there are restrictions on the maximum number of board types which can be added anew or the entire board type list length, for example, the target device (DVCR 2's controller 17) describes the associated information in the list_specific_information. The controller (IRD 1's controller 11) can be provided with these restrictions in advance.

Non_info_block_fields_length contains the number of bytes for non info block fields. Board_type describes a value indicating the general board type. Object_list_maximum_size describes the maximum object list size of the general board. Object_entry_naximum_number contains the maximum number of object entries. Board_type_dependent_information_length contains the length of board_type_dependent_information. Board_type_dependent_information maintains information specific to the board type.

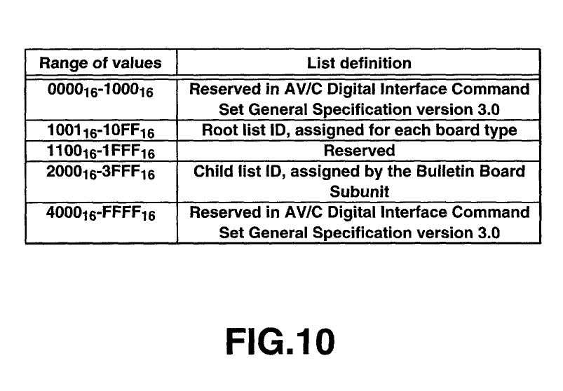

FIG. 10 shows an allocation table of list IDs for the BBS version 1.0. The general board according to the embodiment is indicated by one root list. A general board type value is determined in an available range of root list IDs between “1001₁₆” and “10FF₁₆”.

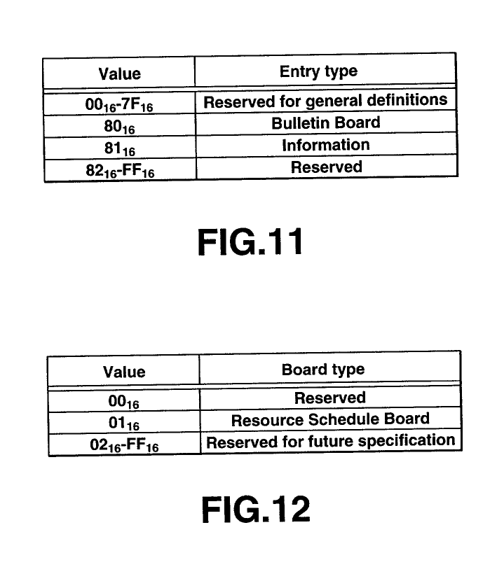

FIG. 11 shows an allocation table of list types. In this embodiment, the board type list is defined to be “82₁₆”.

FIG. 12 shows an allocation table of board types. In this embodiment, the general board type uses “00₁₆”.

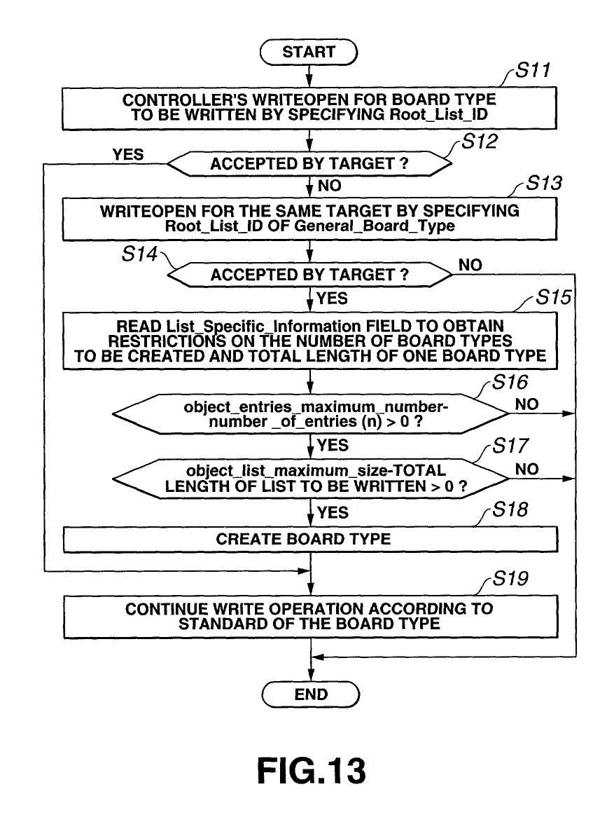

FIG. 13 is a flowchart showing a flow of processing until a new board type is created in the system according to the embodiment of the present invention as shown in FIG. 2.

At step S11 in FIG. 13, the IRD's controller 11 specifies the root list ID (fixed value) to “write-open” a board type to be written to the BBS 16 of the DVCR 3 as a target device. This write-open instruction is performed when the controller 11 issues a WRITE OPEN command to be described later.

At step S12, the controller 11 checks whether the controller 17 of the DVCR 3 (target device) returns an accept in response to the WRITE OPEN command. When an accept returns, control proceeds to step S19 for performing a write operation and the like according to the standard of the board type.

When no accept returns from the target device (DVCR 3), the controller 11 performs a write-open instruction by specifing Root_List_ID for the general board type for the target device (DVCR 3).

At step S 13, the controller 11 checks whether the controller 17 of the target device (DVCR 3) returns an accept in response to the WRITE OPEN command. When no accept returns, the processing terminates.

When the target device returns an accept in response to the write-open instruction with Root_List_ID specified for the general board type, the controller 11 reads data at the List_Specific_Information field in the BBS 16 for the DVCR 3 (target device) at step S14. By doing so, the controller 11 recognizes restrictions on the number of board types to be created and the total length of one board type.

At step S 15, the controller 11 performs an operation (object_entries_maximum_number)-(number_of_entries(n))>0 for determination. When the result is false (less than or equal to 0), the controller 11 terminates the processing. When the result is true, control proceeds to step S17.

At step S 17, the controller 11 performs an operation (object_lists_maximum_size)−(total length of a list to be written) >0 for determination. When the result is false (less than or equal to 0), the controller 11 terminates the processing. When the result is true, control proceeds to step S18.

At step S18, the controller 11 issues an instruction for creating an object to the board type list descriptor. This “create” instruction is performed when the controller 11 issues a CREATE command to be described later. When receiving the CREATE command, the controller 17 of the DVCR 3 (target device) creates an object with child list ID for the BBS 16. Then, the IRD l's controller 1 writes an ID value of the board type to be created onto the corresponding child list ID. This creates a new board type. The board type creation at step S18 will be described later in detail.

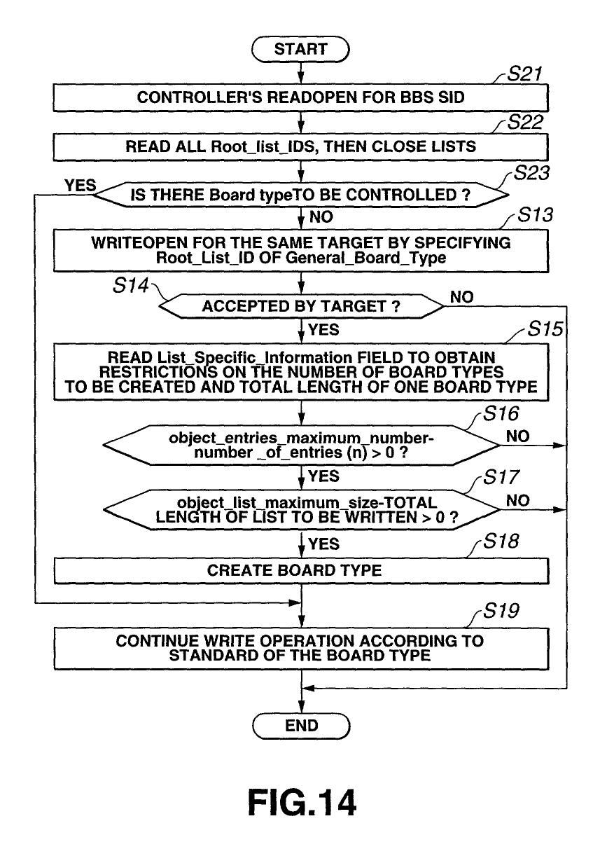

It is also possible to perform processing for creating a new board type in the system according to the embodiment of the present invention as shown in FIG. 2. In FIG. 14, the process at step S 13 and later processes are same as those for the example in FIG. 13. The description thereof is omitted.

At step S21 in FIG. 14, the IRD l's controller 11 performs a read-open instruction for the SID in the BBS 16 of the DVCR 3 as a target device. This “read-open” instruction is performed when the controller 11 issues a CREATE command to be described later.

At step S22, the controller 11 reads all root_list_IDs from the SID, and then closes these lists. This “close” instruction is performed when the controller 11 issues a CLOSE command to be described later.

At step S23, the controller 11 checks whether a board type to be controlled is available. When such a board type is available, control proceeds to step S19 above. When no such board type is available, control proceeds to step S13 above.

The process at step S13 and later processes are same as those described in FIG. 13.

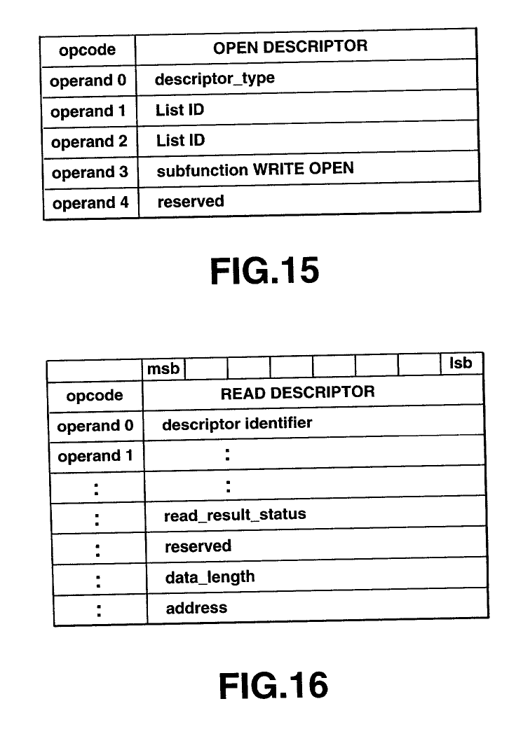

FIG. 15 shows a format of the WRITE OPEN command issued from the controller 11 to a target device.

A WRITE OPEN command in this FIG. 15 is a type of OPEN DESCRIPTOR command used for accessing a specified address space of the target. In this WRITE OPEN command, opcode describes a value indicating an open descriptor. Operand 0 describes descriptor_type indicating a type of descriptor for write-open. Operands 1 and 2 describe list IDs to be accessed for write-open. Operand 3 describes a value indicating that the subfunction is a write-open instruction, namely opening the descriptor for read or write access. Operand 4 is reserved.

FIG. 16 shows a format of the READ command issued from the controller 11 to a target device.

In this READ command format, the first opcode describes a value indicating a read descriptor. The succeeding operand 0 describes a descriptor identifier for identifying a descriptor to be read. Read_result_status contains “FF₁₆” when a posting device issues the READ command. Alternatively, it contains a read result when the target device returns a response. Data_length describes the number of data bytes to be read from the target. When the data_length value is set to “00₁₆”, all lists are read. Address describes an address to start reading. When the address value is set to “00₁₆”, a read operation starts from the beginning.

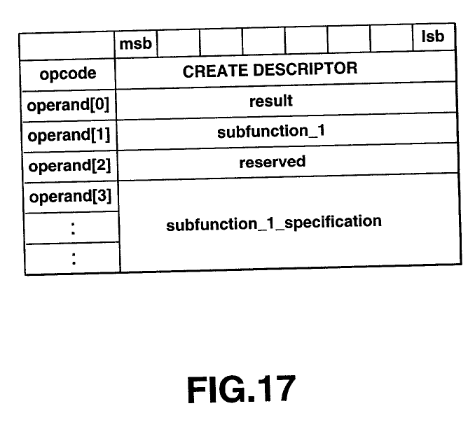

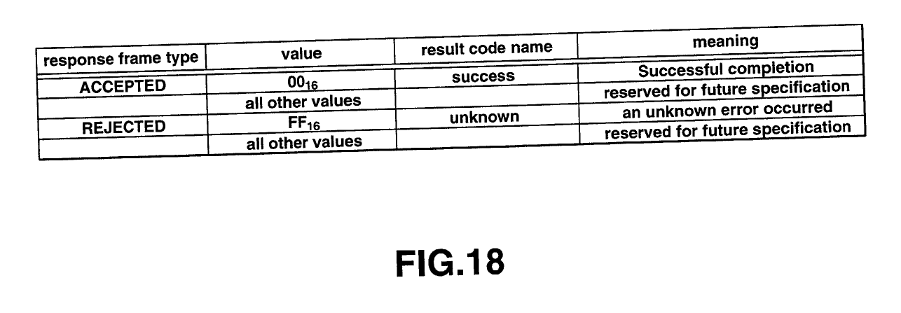

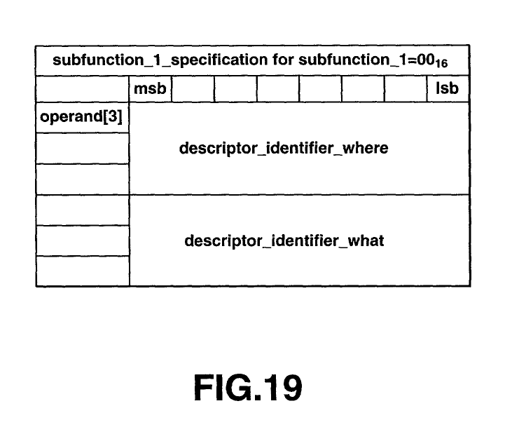

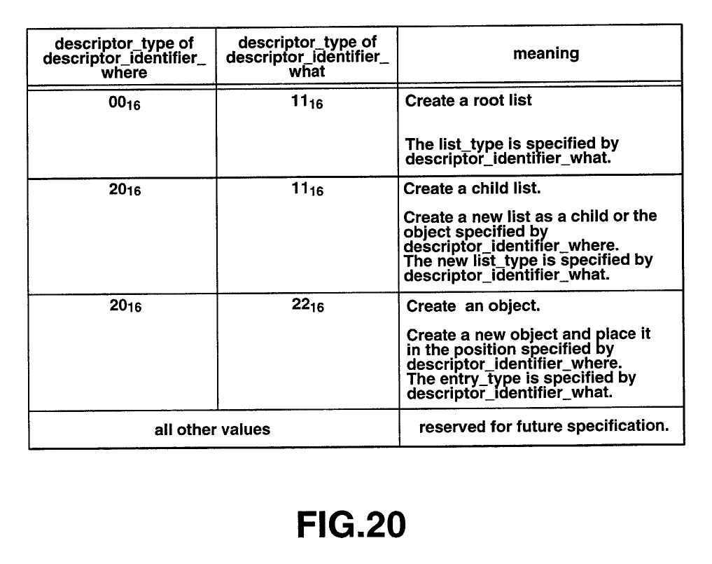

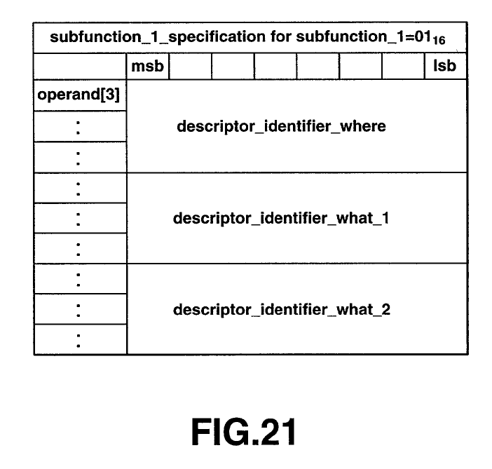

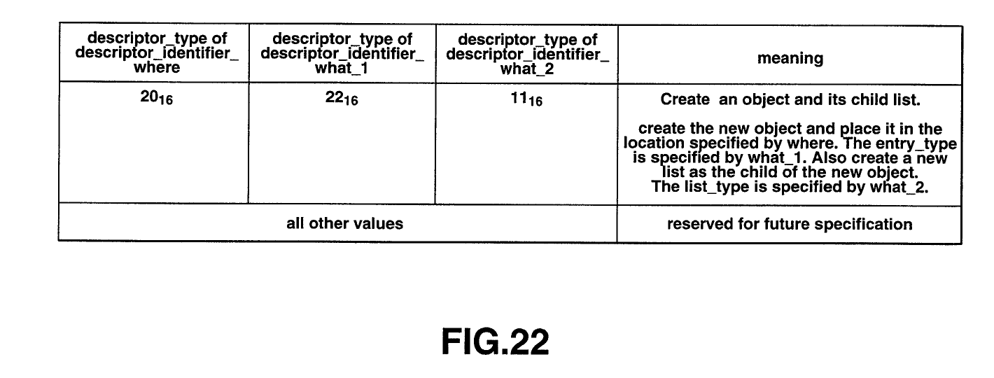

FIG. 17 shows a format of the CREATE command issued from the controller 11 to a target device. FIG. 18 shows the content of the result field in FIG. 17. FIG. 19 shows the format of subfunction_1_specification for subfunction_1=00₁₆ in FIG. 17. FIG. 20 shows result field values and meanings thereof FIG. 21 shows the format of subfunction_1_specification for subfunction_1=01₁₆ in FIG. 17. FIG. 22 shows field values in FIG. 21. In FIG. 22, values “20₁₆ ”, “22₁₆”, and “11₁₆” are placed in the fields descriptor_identifier_where, descriptor_identified_what_{—}1, and descriptor_identified_what_{—}2 in FIG. 21, respectively. The setting of these fields means “create a new object and its child list”. When a new board type is created as described in this embodiment, the descriptor_identifier_where field in FIG. 21 describes the general board's root list ID and a value (object position) indicating which entry should be used. The descriptor_identified_what_{—}1 field describes a specified value for the entry type. This value is specified for a template of the board type including the child list ID. The descriptor_identified_what_{—}2 field describes a specified value for a template corresponding to the list type.

This description is provided with reference to documents such as “Enhancement to the AV/C General Specification 3.0 Version 1.0 FC2” and “TA Document 1999005 AV/C Bulletin Board Subunit General Specification 1.0 Draft 0.99:149”.

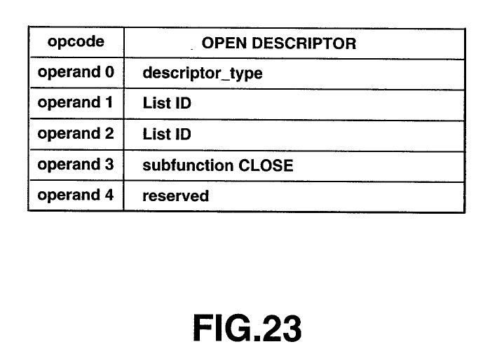

FIG. 23 shows a format of the CLOSE command issued from the controller 11 to a target device.

Basically, the CLOSE command format in FIG. 23 is same as the WRITE OPEN command format in FIG. 15. A difference is that the subfunction value in FIG. 15 indicates WRITE OPEN and the same value for the CLOSE command in FIG. 23 indicates CLOSE. The other configurations are same as those in FIG. 15.

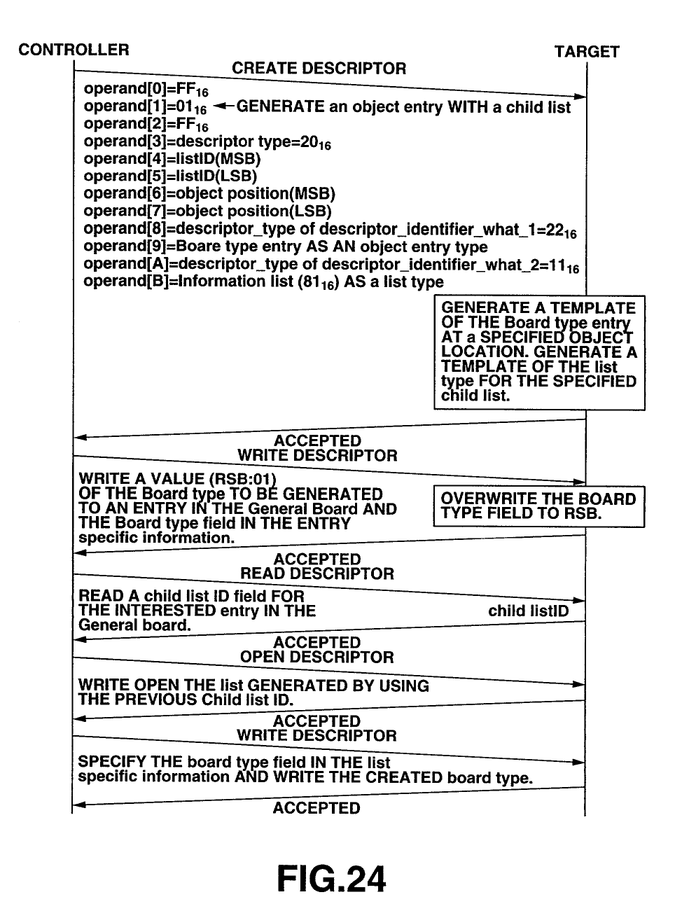

The board type creation at step S 18 in FIGS. 13 and 14 will be described later in detail with reference to FIG. 24

In FIG. 15, the controller 11 issues a “create” descriptor of the CREATE command to the controller 17 of the DVCR 3 (target device). At this time, the create descriptor contains operands having the following values. Operand[0] describes “FF₁₆”. Operand[1] describes “01₁₆”. Operand[2] describes “FF₁₆”. Operand[3] describes descriptor type=20₁₆. Operand[4] describes listID (MSB). Operand[5] describes listID (LSB). Operand[6] describes object position (MSB). Operand[7] describes object position (LSB). Operand[8] describes descriptor_type of descriptor_identifier_what_{—}1=22₁₆. Operand[9] describes Board type entry as an object entry type. Operand[A] describes descriptor_type of descriptor_Identifier_what_{—}2=11₁₆ Operand[B] describes Information list (81₁₆) as a list type.

When receiving the create descriptor, the target device generates a board type entry template at the specified object position. The target device generates a list type template for the specified child list, and then returns an accept to the controller 11.

The controller 11 then issues a write descriptor of the WRITE OPEN command. The controller writes a value of the board type to be generated to an entry in the general board and the board type field in the entry specific information. When the board type is a resource schedule board (RSB), the value 01₁₆ is written.

When receiving the write descriptor, the target device overwrites the board type field on the content of the specified board, say, RSB, and then returns an accept to the controller 11.

The controller then issues a read descriptor of the READ command. AT this time, the controller 11 reads the child list ID in an interested entry from the general i board.

When receiving the read descriptor, the target device provides a child list ID and returns an accept to the controller 11.

The controller 11 then issues an open descriptor for the OPEN command. At this time, the controller 11 performs a write-open instruction for the list generated through the use of the child list ID.

When receiving the open descriptor, the target device returns an accept to the controller 11.

The controller 11 then issues a write descriptor for the WRITE OPEN command. At this time, the controller 11 specifies the board type field in the list specific information and writes the created board type.

When receiving the write descriptor, the target device then returns an accept to the controller 11.

According to the embodiment of the present invention as mentioned above, the controller can later add a board type to a device which has a large amount of memory and the BBS, and provides networked devices with the BBS as a space for sharing information. The controller can handle, say, the most recent board type.

Since the embodiment of the present invention allows a board type to be added later, it is unnecessary for memory to store a complete list of board types available to devices at the time of shipment. It is possible to newly create a list of board types according to user's selection, permitting an effective use of memory.

According to the embodiment of the present invention, a series of processing as mentioned above can be implemented by software as well as hardware. When the software is used for performing a series of processing, a program constituting the software is installed on the controller as dedicated hardware. Alternatively, the program can be installed on a general-purpose personal computer for providing various functions.

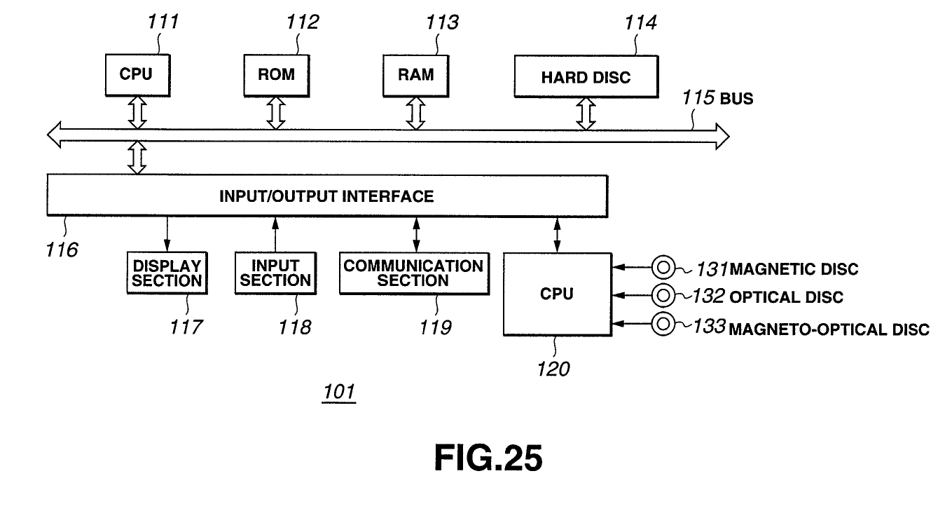

As shown in FIG. 25, a general-purpose personal computer 101 includes a CPU (Central Processing Unit) 111. The CPU 111 is connected to an input/output interface 116 via a bus 115. A user's instruction is entered from an input section 118 comprising a keyboard, a mouse, and the like via the input/output interface 116. According to this instruction, the CPU 111 reads a program for executing a series of the abovementioned processing from a storage medium and writes the program to RAM (Random Access Memory) 113 for execution. The storage media include ROM (Read Only Memory) 112 and a hard disc 114, or a magnetic disc 131, an optical disc 132, a magneto-optical disc 133, and semiconductor memory (not shown) mounted on a drive 120. Programs stored in the hard disc 114 include not only preinstalled programs distributed to users, but also programs which are transferred from a satellite or a network and are received and downloaded by a communication section 119.

The CPU 111 outputs a picture signal out of the processing result to a display section 117 comprising an LCD (Liquid Crystal Display), a CRT (Cathode Ray Tube), and the like via the input/output interface 116.

While there have been described specific preferred embodiments of the present invention, it is to be distinctly understood that the present invention is not limited thereto but may be otherwise variously embodied within the spirit and scope of the invention. For example, according to the embodiment, there has been provided an example in which the IRD 1's controller 11 creates a new board for the DVCR 3's BBS 16. It is also possible that a controller of another device or unit may create a new board for the DVCR 3's BBS 16.

What is claimed is:

1. An information processing apparatus having shared information storage means for storing information shareable among other networked information processing apparatuses and including one or more types of information description area, comprising:
data input means for inputting data from said another networked information processing apparatus; and
information description area generation means for, based on data from said data input means, generating a new information description area having an identification information write area for writing identification information indicating a type of said information description area.

2. The information processing apparatus according to claim 1, comprising write restriction recording means for recording write restriction information when writing to said information description area.

3. The information processing apparatus according to claim 2, wherein said write restriction information is the maximum number of said types.

4. The information processing apparatus according to claim 1, comprising storage means for storing compression information by previously compressing template information in an information description area having said identification information write area, wherein
said information description area generation means comprises decompression means for decompressing compression information saved in said storage means in response to a request from said another information processing apparatus.

5. The information processing apparatus according to claim 1, wherein
said information description area generation means comprises read means for reading information from a storage medium; and
responds to a request from said another information processing apparatus and reads said template information from a storage medium storing template information of an information description area having said identification information write area.

6. The information processing apparatus according to claim 1, wherein said information description area generation means comprises acquisition means for acquiring said template information via a network or a commination line from a server storing template information for an information description area having said identification information write area in response to a request from said another information processing apparatus.

7. An information processing method for an information processing apparatus capable of having shared information storage means for storing information shareable among other networked information processing apparatuses and including one or more types of information description area, comprising:
a data input step of inputting data from said another networked information processing apparatus; and
an information description area generation step of, based on data from said data input means, generating a new information description area having an identification information write area for writing identification information indicating a type of said information description area.

8. The information processing method according to claim 7, comprising:
a storage step of storing compression information by previously compressing template information in an information description area having said identification information write area; and
a decompression step of decompressing said compression information in response to a request from said another information processing apparatus.

9. The information processing method according to claim 7, comprising a read step of responding to a request from said another information processing apparatus and reading said template information from a storage medium storing template information of an information description area having said identification information write area.

10. The information processing method according to claim 7, comprising an acquisition step of acquiring said template information via a network or a coli-inaction line from a server storing template information for an information description area having said identification information write area in response to a request from said another information processing apparatus.

11. An information processing apparatus connected with another information processing apparatus having shared infonnation storage means for storing information shareable among other networked infonnation processing apparatuses and including one or more types of information description area, comprising:
request means for requesting to generate a specified type of infonnation description area; and
write means for writing identification information indicating said specified type of said infonnation description area to a write area for identification information indicating a type of said infonnation description area provided in said infonnation description area newly generated by said another infonnation processing apparatus in response to said request.

12. The information processing apparatus according to claim 11, comprising acquisition means for acquiring write restriction information when writing to said information description area.

13. The infonnation processing apparatus according to claim 12, wherein said write restriction information is the maximum number of said types.

14. The information processing apparatus according to claim 11, comprising determination means for determining whether said type of infonnation description area is already generated in said another information processing apparatus, wherein
when said determination means determines that said type of information description area is not generated, said request means requests to generate said type of information description area.

15. The information processing apparatus according to claim 1 1, wherein said request means requests where to generate said type of infonnation description area.

16. An infonnation processing method of writing infonnation to another information processing apparatus capable of having shared infonnation storage means for storing information shareable among other networked information processing apparatuses and including one or more types of information description area, comprising:
a request step of requesting to generate a specified type of information description area; and
a write step of writing identification information indicating said specified type of said infonnation description area to a write area for identification infonnation indicating a type of said information description area provided in said information description area newly generated by said another information processing apparatus in response to said request.

17. The information processing method according to claim 16, comprising an acquisition step of acquiring write restriction infonnation when writing to said information description area.

18. The information processing method according to claim 17, wherein said write restriction information is the maximum number of said types.

19. The infonnation processing method according to claim 16, comprising a determination step of determining whether said type of information description area is already generated in said another information processing apparatus, wherein
when said determination step determines that said type of infonnation description area is not generated, said request step requests to generate said type of information description area.

20. The information processing method according to claim 16, comprising a step of requesting where to generate said type of information description area.

21. An infonnation processing system comprising a first infonnation processing apparatus having shared information storage means for storing infonnation shareable among respective networked information processing apparatuses and including one or more types of infonnation description area and a second information processing apparatus networked to said first information processing apparatus, wherein
said first infonnation processing apparatus comprising:
data input means for inputting data from said second information processing apparatus; and
information description area generation means for, based on data from said data input means, generating a new information description area having an identification information write area for writing identification infonnation indicating a type of said information description area, and
said second information processing apparatus comprising:
request means for transmitting request data requesting said information processing apparatus to generate a specified type of infonnation description area; and
write means for writing identification infonnation indicating said specified type of said infonnation description area to a write area for said identification information in said infonnation description area newly generated by said first infonnation processing apparatus in response to said request data.

22. The information processing system according to claim 21, wherein
said first information processing apparatus comprises storage means for storing compression infonnation by previously compressing template information in an infonnation description area having said identification information write area; and
said information description area generation means for said first information processing apparatus comprises decompression means for decompressing compression information saved in said storage means in response to a request from said second information processing apparatus.

23. The information processing system according to claim 21, wherein said infonnation description area generation means of said first infonnation processing apparatus comprises read means for reading information from a storage medium; and
responds to a request from said second information processing apparatus and reads said template infonnation from a storage medium storing template infonnation of an infonnation description area having said identification infonnation write area.

24. The information processing system according to claim 21, wherein said infonnation description area generation means of said first infonnation processing apparatus comprises acquisition means for acquiring said template infonnation via a network or a commination line from a server storing template infonnation for an information description area having said identification infonnation write area in response to a request from said second information processing apparatus.

25. An infonnation processing method of writing infonnation to a first information processing apparatus capable of having shared information storage means for storing infonnation shareable among respective networked information processing apparatuses and including one or more types of infonnation description area, comprising:
a request step of requesting said information processing apparatus to generate a specified type of infonnation description area;
a generation step of generating a new information description area having an identification infonnation write area for writing identification infonnation indicating said type of information description area in response to said request; and
a write step of writing identification information indicating said specified type of said information description area to a write area for identification information indicating a type of said infonnation description area provided in said information description area newly generated in response to said request.

26. The infonnation processing method according to claim 25, comprising an acquisition step of acquiring write restriction information when writing to said information description area.

27. The information processing method according to claim 26, wherein said write restriction information is the maximum nunber of said types.

28. The infonnation processing method according to claim 25, comprising a determination step of determining whether said type of information description area is already generated in said infonnation processing apparatus, wherein
when said determination step determines that said type of information description area is not generated, said request step requests to generate said type of information description area.

29. The information processing method according to claim 25, wherein said request step also requests where to generate said type of infonnation description area.

30. The information processing method according to claim 25, comprising:
a storage step of storing compression information by previously compressing template information in an information description area having said identification information write area; and
a decompression step of decompressing said stored compression information in response to said request.

31. The information processing method according to claim 25, comprising a read step of responding to a request from said another infonnation processing apparatus and reading said template infonnation from a storage medium storing template infonnation of an information description area having said identification information write area.

32. The information processing method according to claim 25, comprising an acquisition step of acquiring said template infonnation via a network or a commination line from a server storing template infonnation for an information description area having said identification information write area in response to said request.

33. A medium storing a program for performing infonnation processing on an infonnation processing apparatus capable of storing information shareable among other networked infonnation processing apparatuses and including one or more types of information description area, wherein said program comprising the steps of:
inputting an request from said another networked information processing apparatus; and
generating a new infonnation description area having an identification information write area for writing identification information indicating a type of said information description area in response to said request.

34. A medium storing a program for performing information processing on an infonnation processing apparatus networked with another infonnation processing apparatus, wherein said program comprising the steps of:
issuing a request to generate a specified type of infonnation description area to another information processing apparatus having shared infonnation storage means for storing infonnation shareable among respective networked information processing apparatuses and including one or more types of infonnation description area; and
writing identification infonnation indicating said specified type of said infonnation description area to a write area for identification infonnation indicating a type of said infonnation description area provided in said information description area newly generated by said another infonnation processing apparatus in response to said request.

35. The program stored in a medium according to claim 34, comprising an acquisition step of acquiring write restriction infonnation when writing to said information description area.

36. The program stored in a medium according to claim 35, wherein said write restriction infonnation is the maximum number of said types.

37. The program stored in a medium according to claim 34, comprising a step of determining whether said type of information description area is already generated in said another information processing apparatus, wherein
when said determination step determines that said type of infonnation description area is not generated, said request step requests to generate said type of information description area.

38. The program stored in a medium according to claim 34, comprising a step of requesting where to generate said type of infonnation description area.

39. A medium storing a program for performing infonnation processing on an infonnation processing apparatus networked with other infonnation processing apparatuses, wherein said program comprising the steps of:
issuing a request to generate a specified type of information description area to shared infonnation storage means for storing information shareable among respective networked information processing apparatuses and including one or more types of information description area;
generating a new information description area having an identification infonnation write area for writing identification information indicating a type of said infonnation description area in response to said request; and
writing identification infonnation indicating said specified type of said n information description area to a write area for identification information indicating a type of said infonnation description area provided in said information description area newly generated in response to said request.
